(19) United States
(12) Patent Application Publication
(10) Pub. No.: US 2017/0313043 A1
(43) Pub. Date: Nov. 2, 2017

(54) CURABLE EPOXY COMPOSITION AND FILM, LAMINATED FILM, PREPREG, LAMINATE, CURED ARTICLE, AND COMPOSITE ARTICLE OBTAINED USING SAME

(71) Applicant: ZEON CORPORATION, Tokyo (JP)

(72) Inventors: Makoto Fujimura, Tokyo (JP); Takeshi Sakano, Tokyo (JP)

(73) Assignee: ZEON CORPORATION, Tokyo (US)

(21) Appl. No.: 15/520,513

(22) PCT Filed: Oct. 27, 2014
(86) PCT No.: PCT/JP2014/078463

§ 371 Date: Apr. 20, 2017

(51) Int. Cl. B32B 27/38; C08G 59/32; C08J 5/18; C08G 59/62; C08G 59/38; C08G 59/24

(52) U.S. Cl. CPC B32B 27/38; C08G 59/38; C08G 59/245; C08J 5/18; C08G 59/623; C08G 59/3218; B32B 2307/202; C08J 2363/02

(57) ABSTRACT

A curable epoxy composition comprising a polyvalent epoxy compound (A) having a biphenyl structure and/or condensed polycyclic structure, a trivalent or higher polyvalent phenol type epoxy compound (B), and a triazine structure-containing phenol resin (C) and a film, laminated film, prepreg, laminate, cured article, and composite article obtained using the same are provided.

### TECHNICAL FIELD

The present invention relates to a curable epoxy composition, film, laminated film, prepreg, laminate, cured article, and composite article.

### BACKGROUND ART

Along with the pursuit of smaller sizes, increased functions, and faster communications in electronic equipment, further higher densities of the circuit boards which are used for the electronic equipment have been sought. To meet such demands for higher densities, circuit boards are being made multilayered. Such multilayer circuit boards are, for example, formed by taking an inside layer board which is comprised of an electrical insulating layer and a conductor layer which is formed on its surface, laminating an electrical insulating layer over it, forming a conductor layer over this electrical insulating layer, and further repeating this lamination of an electrical insulating layer and formation of a conductor layer.

As the material for forming the electrical insulating layer of such multilayer circuit boards, in general ceramics and thermosetting resins are being used. Among these, as thermosetting resins, epoxy resins are being widely used since they are excellent in the point of the balance of economy and performance.

As the epoxy resin material for forming such an electrical insulating layer, for example, Patent Document 1 discloses an epoxy resin, composition containing an (A) epoxy resin, (B) active ester compound, and (C) triazine-containing cresol novolac resin. Patent Document 1 describes that according to such an epoxy resin composition, it is possible to form an insulating layer which exhibits a high bonding force to the plating conductor, regardless of the roughness being small, and is low in linear expansion rate and low in dielectric tangent.

Here, in the multilayer circuit board, the conductor layer and the electrical insulating layer have to be closely bonded, but if the adhesion is weak, peeling may end up occurring daring the process of fabrication or during the mounting of the multilayer circuit board and further during use as a board for an electronic material and reliability is liable to no longer be insufficiently secured.

### RELATED ART

### Patent Documents

Patent Document 1: Japanese Patent Publication No. 2011-132507A

### SUMMARY OF THE INVENTION

### Problem to be Solved by the Invention

Under such circumstances, the present inventors engaged in studies and clarified that when using the above epoxy resin composition according to Patent Document 1 to form an electrical insulating layer of a multilayer printed circuit board, the heat resistance and the electrical characteristics are generally good, but the adhesion with the conductor layer would still be insufficient.

An object of the present invention is to provide a curable epoxy composition able to form an electrical insulating layer excellent in heat resistance and electrical characteristics with a good balance and furthermore excellent also in adhesion with a conductor layer and to provide a film, laminated film, prepreg, laminate, cured article, and composite article using the same.

### Means for Solving the Problem

The present inventors engaged in intensive research to achieve the above object and as a result discovered that according to a curable epoxy composition comprising a polyvalent epoxy compound having a biphenyl structure and/or condensed polycyclic structure, a trivalent or higher polyvalent phenol type epoxy compound, and a triazine structure-containing phenol resin, an electrical insulating layer having the desired characteristics is obtained, and thereby completed the present invention.

That is, according to the present invention, there are provided

(1) A curable epoxy composition comprising a polyvalent epoxy compound (A) having a biphenyl structure and/or condensed polycyclic structure, a trivalent or higher polyvalent phenol type epoxy compound (B), and a triazine structure-containing phenol resin (C),
(2)the curable epoxy composition according to (1), wherein the trivalent or higher polyvalent phenol type epoxy compound (B) includes an epoxy compound having a structure represented by the following general formula (1):

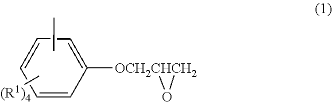

where, in formula (1), each of R¹ respectively independently indicates a hydrogen atom or hydrocarbon group having 1 to 3 carbon atoms,

(3) The curable epoxy composition according to (1) or (2), wherein the trivalent or higher polyvalent phenol type epoxy compound (B) includes an epoxy compound having any one of structures represented by the following general formulas (2) to (5):

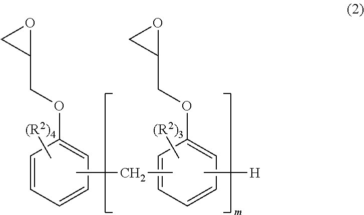

where, in formula (2), each of R² respectively independently indicates a hydrogen atom or hydrocarbon group having 1 to 3 carbon atoms, and “m” is an integer of 2 or more, and

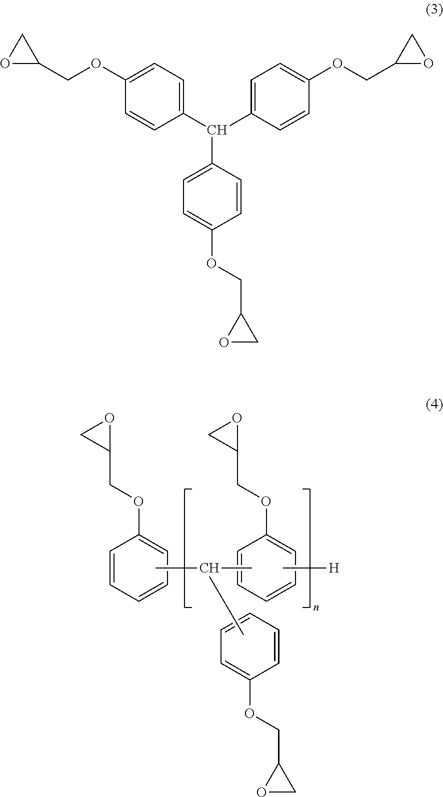

where, in formula (4), “n” indicates a positive integer.

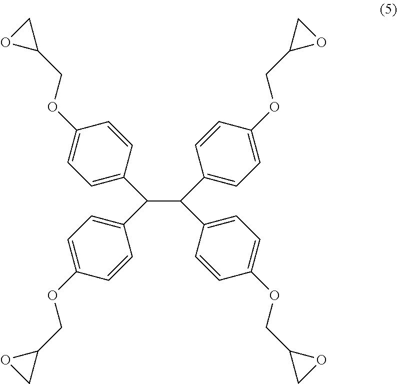 [SMILES: c1cc(C(c2ccc(OCC3CO3)cc2)C(c2ccc(OCC3CO3)cc2)c2ccc(OCC3CO3)cc2)ccc1OCC1CO1]

(4) The curable epoxy composition according to any one of (1) to (3), wherein a ratio of content of the polyvalent epoxy compound (A) and the trivalent or higher polyvalent phenol type epoxy compound (B) is, by a weight ratio of “polyvalent epoxy compound (A): trivalent or higher polyvalent phenol type epoxy compound (B)”, 20:80 to 95:5,
(5) The curable epoxy composition according to any one of (1) to (4), wherein a ratio of content of the triazine structure-containing phenol resin (C) is 1 to 60 parts by weight with respect to 100 parts by weight of total of epoxy compound contained in the curable epoxy composition,
(6) The curable epoxy composition according to any one of (1) to (5), further comprising an active ester compound (D),
(7) A film comprising the curable epoxy composition according to any one of (1) to (6),
(8) A laminated film comprising a binder layer which comprises the curable epoxy composition according to any one of (1) to (6) and a platable layer which comprises a platable layer-use resin composition,
(9) A prepreg comprising the film according to (7) or the laminated film according to (8) and a fiber base material,
(10) A laminate obtained by laminating a substrate with the film according to (7), the laminated film according to (8), or the prepreg according to (9),
(11) A cured article obtained by curing the curable epoxy composition according to (1), (2), (3), (4), (5), or (6), the film according to (7), the laminated film according to (8), the prepreg according to (9), or the laminate according to (10),
(12) A composite article obtained by forming a conductor layer on a surface of the cured article according to (11), and
(13) A board for an electronic material comprising the cured article according to (11) or the composite article according to (12).

### Effects of Invention

According to the present invention, a curable epoxy composition able to form an electrical insulating layer excellent in heat resistance and electrical characteristics with a good, balance and furthermore excellent also in adhesion with a conductor layer and a film, laminated film, prepreg, laminate, cured article, and composite article using the same are provided.

### DESCRIPTION OF EMBODIMENTS

The curable epoxy composition of the present invention is a composition comprising a polyvalent epoxy compound (A) having a biphenyl structure and/or condensed polycyclic structure, a trivalent or higher polyvalent phenol type epoxy compound (B), and a triazine structure-containing phenol resin (C).

[Polyvalent Epoxy Compound (A) Having Biphenyl Structure and/or Condensed Polycyclic Structure]

The polyvalent epoxy compound (A) having a biphenyl structure and/or condensed polycyclic structure used in the present invention (below, sometimes abbreviated as the “polyvalent epoxy compound (A)”) is a compound having at least two epoxy groups (oxirane rings) in its molecule and having at least one of a biphenyl structure and condensed polycyclic structure.

The “biphenyl structure” means a structure containing two benzene rings bonded by a single bond. In the obtained cured resin, the biphenyl structure usually forms the main chain of the resin, but it may also be present at the side chain.

Further, the “condensed polycyclic structure” means a structure containing two or more single rings condensed (condensed rings). The rings forming the condensed polycyclic structure may be an alicyclic ring or may be aromatic ring. Further, they may contain hetero atoms. The number of condensed rings is not particularly limited, but from the viewpoint of raising the heat resistance and the mechanical strength of the obtained electrical insulating layer, two or more rings is preferable. In practice, the upper limit is about 10 rings. As such an condensed polycyclic structure, for example, a dicyclopentadiene structure, naphthalene structure, fluorene structure, anthracene structure, phenanthrene structure, triphenylene structure, pyrene structure, ovalene structure, etc. may be mentioned. In the same way as the above-mentioned biphenyl structure, in the obtained cured resin, the condensed polycyclic structure usually forms the main chain of the resin, but may also be present at the side chain.

The polyvalent epoxy compound (A) used in the present invention has a biphenyl structure, condensed polycyclic structure, or both a biphenyl structure and condensed polycyclic structure, but from the viewpoint of enhancing the heat resistance and mechanical strength of the obtained electrical insulating layer, as the polyvalent epoxy compound (A), one having a biphenyl structure is preferable, while one having a biphenyl aralkyl structure is more preferable.

Further, when jointly using, as the polyvalent epoxy compound (A), one having a biphenyl structure (including one having both a biphenyl structure and condensed polycyclic structure) and one having a condensed polycyclic structure, from the viewpoint of enhancing the heat resistance and electrical characteristics of the electrical insulating layer, the ratio of formulation of these is, by weight ratio (polyvalent epoxy compound having biphenyl structure/polyvalent epoxy compound having condensed polycyclic structure), usually preferably 3/7 to 7/3.

The polyvalent epoxy compound (A) used in the present invention is not limited in structure so long as a compound having at least two epoxy groups in its molecule and having a biphenyl structure and/or condensed polycyclic structure, but from the viewpoint of the heat resistance and mechanical strength of the electrical insulating layer being excellent, a novolac type epoxy compound having a biphenyl structure and/or condensed polycyclic structure is preferable. As the novolac type epoxy compound, a phenol novolac type epoxy compound, cresol novolac type epoxy compound, etc. may be mentioned.

As the polyvalent epoxy compound (A), since a good curing reactivity is obtained, one having an epoxy equivalents of usually 100 to 1500 equivalents, preferably 150 to 500 equivalents is suitable. Note that, in this Description, “epoxy equivalent” is the number of grams of an epoxy compound which includes 1 gram equivalent of epoxy groups (g/eq) and can be measured in accordance with the method of JIS K 7236.

The polyvalent epoxy compound (A) used in the present invention can be suitably produced in accordance with a known method, but can also be acquired as a commercially available product.

As examples of commercially available products of a polyvalent epoxy compound (A) having a biphenyl structure, a novolac type epoxy compound having a biphenyl aralkyl structure, for example, product names “NC3000-FH”, “NC3000-H”, “NC3000”, “NC3000-L”, “NC3100” (above made by Nippon Kayaku); an epoxy compound having a tetramethylbiphenyl structure, for example, product name “YX-4000” (above made by made by Mitsubishi Chemical); etc. may be mentioned.

Further, as examples of commercially available products of a polyvalent epoxy compound (A) having a condensed polycyclic structure, a novolac type epoxy compound having a dicyclopentadiene structure, for example, product names “Epiclon HP7200L”, “Epiclon HP7200”, “Epiclon HP7200H”, “Epiclon HP7200HH”, and “Epiclon HP7200HHH” (above made by DIC, “Epiclon” is a registered trademark), product names “Tactix 556” and “Tactix 756” (above made by Huntsman Advanced Materials, “Tactix” is a registered trademark), product names “XD-1000-1L” and “XD-1000-2L” (above made by Nippon Kayaku); an epoxy compound having a fluorene structure, for example, product names “Oncoat EX-1010”, “Oncoat EX-1011”, “Oncoat EX-1012”, “Oncoat EX-1020”, “Oncoat EX-1030”, “Oncoat EX-1040”, “Oncoat EX-1050”, and “Oncoat EX-1051” (above made by Nagase, “Oncoat” is a registered trademark), product names “Ogsol PG-100”, “Ogsol EG-200”, “Ogsol EG-250” (above made by Osaka Gas Chemical, “Ogsol” is a registered trademark); etc. may be mentioned.

The above polyvalent epoxy compounds (A) can be used independently or as two types or more mixed.

[Trivalent or Higher Polyvalent Phenol Type Epoxy Compound (B)]

The trivalent or higher polyvalent phenol type epoxy compound (B) used in the present invention (below, sometimes abbreviated as “polyvalent phenol type epoxy compound (B)”) is not particularly limited so long as a trivalent or higher polyvalent phenol epoxy compound which does not have a biphenyl structure and/or condensed polycyclic structure, but a trivalent or higher polyvalent hydroxyphenylalkane type epoxy compound is preferable. Here, a “trivalent or higher polyvalent hydroxyphenylalkane type epoxy compound” is a compound having a structure where hydroxyl groups of an aliphatic hydrocarbon substituted by three or more hydroxyphenyl groups are glycidylated.

In the present invention, by jointly using, as the epoxy compound, the above-mentioned polyvalent epoxy compound (A) having a biphenyl structure and/or condensed polycyclic structure and the polyvalent phenol type epoxy compound (B) and using, as the curing agent, the triazine structure-containing phenol resin (C), the obtained electrical insulating layer can be made excellent in heat resistance and electrical characteristics with a good balance and also excellent in adhesion with a conductor layer (in particular, adhesion with the conductor layer after a high temperature and high humidity test).

Among such trivalent or higher polyvalent hydroxyphenylalkane type epoxy compound as well, trivalent or tetravalent polyvalent hydroxyphenylalkane type epoxy compound is more preferable. Among these as well, a trishydroxyphenylmethane-type epoxy compound and tetrakishydroxyphenylmethane-type epoxy compound may be particularly preferably used.

Among such trivalent or higher polyvalent hydroxyphenylalkane type epoxy compound as well, epoxy compound having a structure shown by the following general formula (1) is preferable, while epoxy compounds having any one of structures shown, by the following general formula (2) to (5) are more preferable:

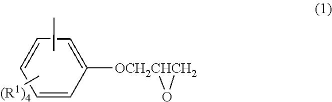

where, in formula (1), each of R¹ respectively independently indicates a hydrogen atom or hydrocarbon group having 1 to 3 carbon atoms,

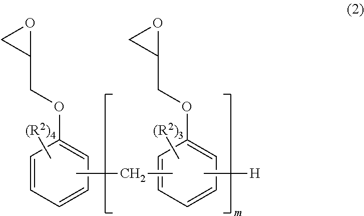

where, in formula (2), each of R² respectively independently indicates a hydrogen atom or hydrocarbon group having 1 to 3 carbon atoms, and “m” is an integer of 2 or more,

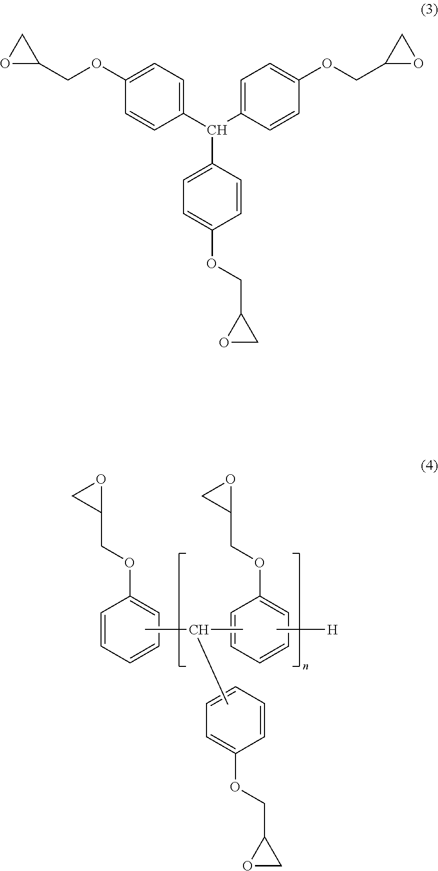

where, in formula (4), “n” is a positive integer:

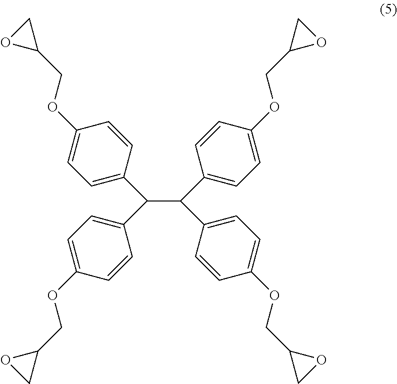 [SMILES: c1cc(C(c2ccc(OCC3CO3)cc2)C(c2ccc(OCC3CO3)cc2)c2ccc(OCC3CO3)cc2)ccc1OCC1CO1]

The polyvalent phenol type epoxy compound (B) used in the present invention can be suitably produced in accordance with a known method, can also be acquired as a commercially available product.

For example, as examples of the commercially available products of a trishydroxyphenylmethane-type epoxy compound, product names “EPPN-503”, “EPPN-502H”, and “EPPN-501H” (above made by Nippon Kayaku), product name “TACTIX-742” (above trade by Dow Chemical), “jER 1032H60” (above made by made by Mitsubishi Chemical), etc. may be mentioned. Further, as examples of the commercially available products of a tetrakishydroxyphenylethane-type epoxy compound, product, name “jER 1031S” (above made by made by Mitsubishi Chemical) etc. may be mentioned.

In the curable epoxy composition or the present invention, the content of the polyvalent phenol type epoxy compound (B) is not particularly limited, but, in relation to the above-mentioned polyvalent epoxy expound (A), the content is preferably made, in terms of the weight ratio of the “polyvalent epoxy compound (A):polyvalent phenol type epoxy compound (B)”, 20:80 to 95:5 in range, more preferably 30:70 to 90:10 in range, still more preferably 40:60 to 85:15 in range. In the curable epoxy composition of the present invention, by making the content of the polyvalent phenol type epoxy compound (B) the above range in relation to the above-mentioned polyvalent epoxy compound (A), the obtained electrical insulating layer can be enhanced more in heat resistance, electrical characteristics, and adhesion with the conductor layer.

(Other Epoxy Compounds)

Further, the curable epoxy composition of the present invention may suitably contain, in addition to the above-mentioned polyvalent, epoxy compound (A) and polyvalent phenol type epoxy compound (B), as desired, another epoxy compound other than these epoxy compounds. As such other epoxy compound, for example, a phosphorus-containing epoxy compound may be mentioned. As the phosphorus-containing epoxy compound, an epoxy compound having a phosphaphenanthrene structure can be preferably mentioned. By further using such an epoxy compound having a phosphaphenanthrene structure, the obtained electrical insulating layer can be further improved in heat resistance, electrical characteristics, and adhesion with the conductor layer and improved in desmearing property (ease of removal of smears by desmearing).

The epoxy compound having a phosphaphenanthrene structure is not particularly limited so long as an epoxy compound having phosphaphenanthrene structure shown by the following formula (6), but, for example, a biphenyl type epoxy compound having a phosphaphenanthrene structure, a bisphenol type epoxy compound having a phosphaphenanthrene structure, a phenol-based novolac type epoxy compound having a phosphaphenanthrene structure, etc. may be mentioned.

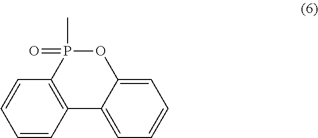 [SMILES: CP1(=O)Oc2ccccc2-c2ccccc21]

As the biphenyl type epoxy compound having a phosphaphenanthrene structure, various types of biphenyl type epoxy compounds having a phosphaphenanthrene structure which are obtained by using 9,10-dihydro-9-oxa-10-phosphaphenantrene-10-oxide or its derivatives to modify a biphenyl type epoxy resin by a method etc. any be mentioned. As examples of such a compound, while not particularly limited, an epoxy compound obtained by modification of YX-4000 made by Mitsubishi Chemical which is an epoxy compound having a tetramethylbiphenyl structure using 9,10-dihydro-9-oxa-10-phosphaphenanthrene-10-oxide etc. may be mentioned.

Further, as the bisphenol type epoxy compound having a phosphaphenanthrene structure, various types of bisphenol type epoxy compounds having a phosphaphenanthrene structure obtained by using 9,10-dihydro-9-oxa-10-phosphaphenanthrene-10-oxide or its derivatives to modify a bisphenol type epoxy resin such as a bisphenol A type epoxy resin or bisphenol F type epoxy resin by a known method etc. may be mentioned. As an example of such a compound, while not particularly limited, FX305EK70 made by Nippon Steel & Sumikin Chemical may be mentioned.

Furthermore, as the phenol-based novolac type epoxy compound having a phosphaphenanthrene structure, various types of phenol-based novolac type epoxy compounds having a phosphaphenanthrene structure obtained by using 9,10-dihydro-9-oxa-10-phosphaphenanthrene-10-oxide or its derivatives to modify a phenol-based novolac type epoxy resin by a known method etc. may be mentioned. As an example of such a compound, while not particularly limited, for example, FX289BEK75 made by Nippon Steel & Sumikin Chemical may be mentioned.

The epoxy compound having a phosphaphenanthrene structure used in the present invention need only be one having one or more epoxy groups in its molecule, but from the viewpoint of being possible to improve the cross-linking density and thereby enable the obtained electrical insulating layer to be improved in mechanical strength, heat resistance, levering of coefficient of linear expansion, and in turn, electrical characteristics, a polyvalent epoxy compound, having at least two epoxy groups in its molecule is preferable.

When the curable epoxy composition of the present invention contains, as the other epoxy compound, an epoxy compound having a phosphaphenanthrene structure, the ratio of content of the epoxy compound having a phosphaphenanthrene structure is not particularly limited so long as not obstructing the expression of the effect of the present invention, but is preferably 20 to 90 wt % in 100 wt % of the total of the epoxy compounds contained in the curable epoxy composition of the present invention, more preferably 30 to 70 wt %. In particular, by using, as the other epoxy compound, an epoxy compound having a phosphaphenanthrene structure and making the ratio of content the above range, the obtained electrical insulating layer can be further enhanced in effect of improvement of the heat resistance, electrical characteristics, adhesion with the conductor layer, and desmearing property.

Note that, as the other epoxy compound, other than an epoxy compound having a phosphaphenanthrene structure or in addition to this, an alicyclic type epoxy compound, cresol novolac type epoxy compound, phenol novolac type epoxy compound, bisphenol A novolac type epoxy compound, trisphenol type epoxy compound, tetrakis(hydroxyphenyl)ethane-type epoxy compound, aliphatic chain type epoxy compound, etc. may be used. These can be suitably acquired as commercially available products.

[Triazine Structure-Containing Phenol Resin (C)]

The triazine structure-containing phenol, resin (C) used in the present invention is a condensed polymer of an aromatic hydroxy compound such as phenol, cresol and naphthol, a compound having a triazine ring such as melamine and benzoguanamine, and formaldehyde. The triazine structure-containing phenol resin (C) typically has a structure represented by the following general formula (7):

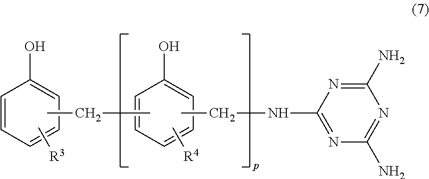

where, in formula (7), each of R³, R⁴ is a hydrogen atom or methyl group, while “p” is an integer of 1 to 30. Further, R³, R⁴ may be the same or different. Furthermore, if “p” is 2 or more, the plurality of R⁴ may be the same or different from each other. Further, in formula (4), for at least one amino group, the hydrogen atom contained in the amino group may be substituted with another group (for example, alkyl group etc.)

The triazine structure-containing phenol resin (C) acts as a curing agent for the epoxy compound used in the present invention due to the presence of the phenolic active hydroxyl group. In particular, by including the triazine structure-containing phenol resin (C), the obtained electrical insulating layer exhibits excellent adhesion with the conductor layer on which that layer is stacked, in particular a conductor layer made of copper.

The triazine structure-containing phenol resin (C) can be produced in accordance with a known method, but can also be acquired as a commercially available product. As examples of such commercially available products, product names “LA7052”, “LA7054”, “LA3018”, and “LA1356” (above made by DIC) etc. may be mentioned.

The above triazine structure-containing phenol resins (C) can be used respectively independently or as two types or more mixed.

In the curable epoxy composition of the present invention, the amount of the triazine structure-containing phenol resin (C) is preferably 1 to 60 parts by weight with respect to 100 parts by weight of the total of the epoxy compounds which are used (that is, the total of the polyvalent epoxy compound (A), the polyvalent phenol type epoxy compound (B), and the other epoxy compound used according to need), more preferably 2 to 50 parts by weight, still more preferably 3 to 40 parts by weight, particularly preferably 4 to 20 parts by weight in range.

Further, in the curable resin composition of the present invention, the equivalent ratio of the epoxy compounds which are used and the triazine structure-containing phenol resin (C) (ratio of total number of active hydroxyl groups of triazine structure-containing phenol resin (C) to total number of epoxy groups of epoxy compounds which are used (amount of active hydroxyl groups/amount of epoxy groups)) is preferably 0.01 to 0.6, more preferably 0.05 to 0.4, still more preferably 0.1 to 0.3 in range. By making the amount of the triazine structure-containing phenol resin (C) the above range, the obtained electrical insulating layer can be further improved in electrical characteristics and heat resistance. Note that, the equivalent ratio of the epoxy compounds which are used and else triazine structure-containing phenol resin (C) can be found from the total epoxy equivalent of the epoxy compounds which are used and the total active hydroxy group equivalent of the triazine structure-containing phenol resin (C).

[Active Ester Compound (D)]

Further, the curable epoxy composition of the present invention preferably contains, in addition to the above components, an active ester compound (D). The active ester compound (D) need only be one having an active ester group, but in the present invention, a compound having at least two active ester groups in its molecule is preferable. The active ester compound (D) acts as a curing agent of the epoxy compounds which are used in the present invention in the same way as the above-mentioned triazine structure-containing phenol resin (C) by reacting the ester parts and epoxy groups by heating.

As the active ester compound (D), from the viewpoint of enhancing the heat resistance of the obtained electrical insulating layer etc., an active ester compound obtained by reacting a carboxylic acid compound, and/or thiocarboxylic acid compound and a hydroxy compound and/or thiol compound is preferable, an active ester compound obtained by reacting a carboxylic acid compound and one or more compounds selects from the group of a phenol compound, naphthol compound, and thiol compound is more preferable, and an aromatic compound obtained by reacting a carboxylic acid compound an aromatic compound having a phenolic hydroxyl group and having at least two active ester groups in its molecule is particularly preferable. The active ester compound (D) may be a linear one or multibranched one. If illustrating the case where the active ester compound (D) is derived from a compound which has at least two carboxylic acids in its molecule, when such a compound which has at least two carboxylic acids in its molecule contains an aliphatic chain, it is possible to raise the compatibility with the epoxy resin, while when it has an aromatic ring, it is possible to raise the heat resistance.

As specific examples of the carboxylic acid compound for forming an active ester compound (D), benzoic acid, acetic acid, succinic acid, maleic acid, itaconic acid, phthalic acid, isophthalic acid, terephthalic acid, pyromellitic acid, etc. may be mentioned. Among these as well, from the viewpoint of raising the heat resistance of the obtained electrical insulating layer, succinic acid, maleic acid, itaconic acid, phthalic acid, isophthalic acid, and terephthalic acid are preferable, phthalic acid, isophthalic acid, and terephthalic acid are particularly preferable, and isophthalic acid and terephthalic acid are furthermore preferable.

As specific examples of the thiocarboxylic acid compound for forming the active ester compound (D), thioacetic acid, thiobenzoic acid, etc. may be mentioned.

As specific examples of the hydroxy compound for forming the active ester compound (D), hydroquinone, resorcine, bisphenol A, bisphenol F, bisphenol S, phenol phthalein, methylated bisphenol A, methylated bisphenol F, methylated bisphenol S, phenol, o-cresol, m-cresol, p-cresol, catechol, α-naphthol, β-naphthol, 1,5-dihydroxynaphthalene, 1,6-dihydroxynaphthalene, 2,6-dihydroxynaphthalene, dihydroxybenzophenone, trihydroxybenzophenone, tetrahydroxybenzophenone, fluoroglycine, benzenetriol, dicyclopentadienyl diphenol, phenol novolac, etc. may be mentioned. Among these as well, from the viewpoints of improving the solubility of the active ester compound (D) and raising the heat resistance of the obtained electrical insulating layer, 1,5-dihydroxynaphthalene, 1,6-dihydroxynaphthalene, 2,6-dihydroxynaphthalene, dihydroxybenzophenone, trihydroxybenzophenone, tetrahydroxybenzophenone, dicyclopentadienyl diphenol, and phenol novolac are preferable, dihydroxybenzophenone, trihydroxybenzophenone, tetrahydroxybenzophenone, dicyclopentadienyl diphenol, and phenol novolac are more preferable, and diyclopentadienyl diphenol and phenol novolac are furthermore preferable.

As specific examples of the thiol compound for forming the active ester compound (D), benxenedithiol, triazinedithiol, etc. may be mentioned.

The method of production of the active ester compound (D) is not particularly limited. It can be produced by a known method. For example, it can be obtained by a condensation reaction between a carboxylic acid compound and/or thiocarboxylic acid compound and hydroxy compound and/or thiol compound.

In the present invention, as the active ester compound (D), for example, an aromatic compound which has an active, ester group disclosed in Japanese Patent Publication No. 2002-12650A or a polyfunctional polyester disclosed in Japanese Patent Publication No. 2004-277460A or a commercially available product may be used. As the commercially available product, for example, product names “EXB9451, EXB9460, EXB9460S, Epiclon HPC-8000-65T” (above, made by DIC, “Epiclon” is a registered trademark), product name “DC808” (made by Japan Epoxy Resin), product name “YLH1026” (made by Japan Epoxy Resin), etc. may be mentioned.

In the curable epoxy composition of the present invention, the amount of the active ester compound (D) is preferably 10 to 150 parts by weight with respect to 100 parts by weight of the total of the epoxy compounds which are used (that is, the total of the polyvalent epoxy compound (A) and polyvalent phenol type epoxy compound (B) and other epoxy compound used as necessary), more preferably 15 to 130 parts by weight, still more preferably 20 to 120 parts by weight in range.

Further, in the curable resin composition of the present invention, the equivalent ratio of the epoxy compounds which are used and the active ester compound (D) (ratio of total number of reactive groups or active ester (D) to total number of epoxy groups of epoxy compound which are used (amount or active ester groups/amount of epoxy groups)) is preferably, 0.5 to 1.1, more preferably 0.6 to 0.9, still more preferably 0.65 to 0.85 in range.

Further, in the curable epoxy composition of the present invention, the equivalent ratio of the epoxy compounds which are used and the triazine structure-containing phenol resin (C) and active ester compound (D) {ratio of total number of epoxy groups of epoxy compounds which are used with respect to the total number of the active hydroxyl groups of the triazine structure-containing phenol resin (C) and the active ester groups of the active ester compound (D) (amount of epoxy groups/(amount of active hydroxyl groups+amount of active ester groups))} is usually less than 1.1, preferably 0.6 to 0.99, more preferably 0.65 to 0.95 in range. By making the above equivalent ratio the above range, in the obtained electrical insulating layer, it is possible to make the electrical characteristics excellent. Note that, the equivalent ratio of the epoxy compound which is used and the triazine structure-containing phenol resin (C) and active ester compound (D) can be found from the total epoxy equivalent of the epoxy compounds which are used, the total active hydroxyl group equivalent of the triazine structure-containing phenol resin (C), and the total active ester equivalent of the active ester compound (D).

(Other Ingredients)

The curable epoxy composition of the present invention may further suitably contain, to an extent not interfering with the expression of the effect of the present invention, other ingredients such as described below in addition to the above-mentioned ingredients.

By mixing a filler into the curable epoxy composition of the present invention, it is possible to make the obtained cured resin low in linear expansion. As that filler, either of a known inorganic filler and organic filler can be used, but an inorganic filler is preferable. As specific examples of an inorganic filler, calcium carbonate, magnesium carbonate, barium carbonate, zinc oxide, titanium oxide, magnesium oxide, magnesium silicate, calcium silicate, zirconium silicate, hydrated alumina, magnesium hydroxide, aluminum hydroxide, barium sulfate, silica, talc, clay, etc. may be mentioned. Note that, the filler used may be surface treated in advance by a silane coupling agent etc. The content of the filler in the curable epoxy composition of the present invention is not particularly limited, but converted to solid content is usually 30 to 90 wt %.

Further, the curable epoxy composition, of the present invention may further contain an alicyclic olefin polymer having a polar group. As the polar group, a group having a structure able to form a covalent bond by reacting an epoxy group, a group having a hetero atom and not having reactivity to an epoxy group may be mentioned, a group having a hetero atom and not having reactivity to an epoxy group is preferable. This alicyclic olefin polymer is one which does not have reactivity with respect to an epoxy group, so therefore substantially does not contain any functional group which has reactivity to an epoxy group. Here, “substantially does not contain any functional group which has reactivity to an epoxy group” means the alicyclic olefin polymer does not contain any functional group which has reactivity with respect to an epoxy group to an extent where expression of the effect of the present invention is obstructed. As a functional group which has reactivity with an epoxy group, a group which has a structure which can react with an epoxy group to form a covalent bond may be mentioned, for example, a primary amino group, secondary amino group, mercapto group, carboxyl group, carboxylic acid anhydride group, hydroxyl group, and epoxy group and other hetero atom-containing functional group which reacts with an epoxy group to form a covalent bond may be mentioned.

The above alicyclic olefin polymer can, for example, be easily obtained by suitably combining and polymerizing, in accordance with a known method, an alicyclic olefin monomer (a) which does not contain a hetero atom but contains an aromatic ring, an alicyclic olefin monomer (b) which does not contain an aromatic ring but contains a hetero atom, an alicyclic olefin monomer (c) which contains both an aromatic ring and hetero atom, and a monomer (d) which does not contain either an aromatic ring and hetero atom and can copolymerize with the alicyclic olefin monomers (a) to (c). The obtained polymer may be further hydrogenated.

In the curable epoxy composition of the present invention, the content of the alicyclic olefin polymer having a polar group is not particularly limited, but it is usually 50 parts by weight or less with respect to 100 parts by weight of the total of the epoxy compounds which are used, preferably 35 parts by weight or less.

The curable epoxy composition of the present invention may, as desired, contain a curing accelerator. The curing accelerator is not particularly limited, but, for example, an aliphatic polyamine, aromatic polyamine, secondary amine, tertiary amine, acid anhydride, imidazole derivative, organic acid hydrazide, dicyan diamide, and their derivatives, urea derivatives, etc. may be mentioned. Among these as well, an imidazole derivative particularly preferable.

The imidazole derivative is not particularly limited so long as a compound which has an imidazole structure, but, for example, 2-ethylimidazole, 2-ethyl-4-methylimidazole, bis-2-ethyl-4-methylimidazole, 1-methyl-2-ethylimidazole, 2-isopropylimidazole, 2,4-dimethylimidazole, 2-heptadecylimidazole, or other alkyl-substituted imidazole compounds; 2-phenylimidazole, 2-phenyl-4-methylimidazole, 1-benzyl-2-methylimidazole, 1-benzyl-2-ethylimidazole, 1-benzyl-2-phenylimidazole, benzimidazole, 2-ethyl-4-methyl-1-(2′-cyanoethyl)imidazole, or other imidazole compounds which are substituted by aryl groups, aralkyl groups or other hydrocarbon groups which contain cyclic structures etc. may be mentioned. These may be used alone or as two or more types combined.

In the curable epoxy composition of the present invention, the amount of the curing accelerator is usually 0.1 to 10 parts by weight with respect to 100 parts by weight of the total of the epoxy compounds which are used, preferably 0.5 to 8 parts by weight.

Furthermore, the curable epoxy composition of the present invention may suitably have mixed into it, for the purpose of improving the flame retardance of the electrical insulating layer obtained, for example a halogen-based flame retardant, phosphoric acid ester-based flame retardant, or other flame retardant which is mixed into general resin compositions for forming an electrical insulating film.

The curable epoxy composition of the present invention may suitably further contain, as desired, a flame retardant aid, heat resistance stabilizer, weather resistance stabilizer, antiaging agent, ultraviolet absorber (laser processability improving agent), leveling agent, antistatic agent, slip agent, antiblocking agent, anticlouding agent, lubricant, dye, natural oil, synthetic oil, wax, emulsion, magnetic substance, dielectric characteristic adjuster, toughness agent, or other known ingredients.

The method of production of the curable epoxy composition of the present, invention is not particularly limited. The above ingredients may be mixed in as they are or may be mixed in the state dissolved or dispersed in an organic solvent. Part of the above ingredients may be dissolved or dispersed in an organic solvent to prepare a composition and the remaining ingredients mixed with that composition.

(Film)

The film of the present invention is a shaped article obtained by forming the above-mentioned curable epoxy composition of the present invention into a sheet shape or film shape.

When forming the curable epoxy composition of the present invention into a sheet shape or film shape to obtain a shaped article, it is preferable to obtain it by coating, spraying, or casting the curable epoxy composition of the present invention while, in accordance with need, adding an organic solvent, then drying.

As the support which is used at this time, a resin film or metal foil etc. may be mentioned. As the resin film, a polyethylene terephthalate film, polypropylene first polyethylene film, polycarbonate film, polyethylene naphthalate film, polyacrylate film, nylon film, etc. may be mentioned. Among these films, due to the excellent heat resistance, chemical resistance, peelability, etc., a polyethylene terephthalate film or polyethylene naphthalate film is preferable. As the metal foil, a copper foil, aluminum foil, nickel foil, chromium foil, gold foil, silver foil, etc, may be mentioned.

The thickness of the sheet shape or film shape shaped article is not particularly limited, but from the viewpoint of the work efficiency etc., it is usually 1 to 150 μm, preferably 2 to 100 μm, more preferably 5 to 80 μm.

As the method of coating the curable epoxy composition of the present invention, dip coating, roll coating, curtain coating, die coating, slit coating, gravure coating, etc. may be mentioned.

Note that, in the present invention, as the sheet shape or film shape shaped article, the curable epoxy composition of the present invention is preferably in an uncured or semicured state. Here, “uncured” means the state where when dipping a shaped article in a solvent which is able to dissolve the epoxy compounds which are used for preparation of the composition, substantially all of the epoxy compound are dissolved. Further, “semicured” means the state of being partially cured to an extent enabling further curing upon heating, preferably a state where parts of the epoxy compounds which are used for preparation of the composition (specifically, amounts of 7 wt % or more and amounts where parts remain) is dissolved in a solvent able to dissolve the epoxy compound or a state where the volume after dipping the shaped article in the solvent for 24 hours is 200% or more of the volume before dipping (swelling rate).

Further, the curable epoxy composition of the present invention may be coated on a support, then dried if desired. The drying temperature is preferably made a temperature of an extent whereby the curable epoxy composition of the present invention does not cure. It is usually 20 to 300° C., preferably 30 to 200° C. If the drying temperature is too high, the curing reaction proceeds too much and the obtained shaped article is liable to no longer become the uncured or semicured state. Further, the drying time is usually 30 seconds to 1 hour, preferably 1 minute to 30 minutes.

The thus obtained film of the present invention is used in a state adhered to the support or peeled off from the support.

(Laminated Film)

The laminated film of the present invention has an adhesive layer which is comprised of the above-mentioned curable epoxy composition and a platable layer which is comprised of a platable layer-use resin composition.

The platable layer is not particularly limited, but from the viewpoint of improving the laminated film in electrical characteristics and heat resistance, one where at least 50 wt % of the resin comprising that layer is comprised of an alicyclic olefin polymer is preferable. As a platable layer-use resin composition for forming such a platable layer, usually an alicyclic olefin polymer which has a polar group and one which contains a curing agent is preferable.

The alicyclic olefin polymer which has a polar group is not particularly limited. One which has an alicyclic structure constituted by a cycloalkane structure or cycloalkene structure etc. may be mentioned. But due to superior in the mechanical strength, heat resistance, etc., one which has a cycloalkane structure is preferable. Further, as the polar group which is contained in the alicyclic olefin polymer, an alcoholic hydroxyl group, phenolic hydroxyl group, carboxyl group, alkoxyl group, epoxy group, glycidyl group, oxycarbonyl group, carbonyl group, amino group, carboxylic anhydride group, sulfonic group, phosphoric group, etc. may be mentioned. Among these as well, a carboxyl group, carboxylic anhydride group, and phenolic hydroxyl group are preferable, while a carboxylic anhydride group is more preferable.

The curing agent which is included in the platable layer-use resin composition is not particularly limited so long as one which can form a cross-linked structure in the alicyclic olefin polymer which has a polar group by heating. It is possible to use a curing agent which is mixed in a resin composition for use in forming a general electrical insulating film. As the curing agent, it is preferable to use a compound which has two or more functional groups which can form bonds by reaction with the polar groups of the used alicyclic olefin polymer which has a polar group.

For example, as the curing agent which is suitably used when using an alicyclic olefin polymer which has a carboxyl group, carboxylic anhydride group, or phenolic hydroxy group as the alicyclic olefin polymer which has a polar group, a polyepoxy compound, polyisocyanate compound, polyamine compound, polyhydrazide compound, aziridine compound, basic metal oxides, organometallic halide, etc. may be mentioned. These may be used alone or may be used in two or more types. Further, it is also possible to jointly use these compounds and peroxides as a curing agent.

Among these, as a curing agent, since the reactivity with the polar groups of the alicyclic olefin polymer which has a polar group is moderate and the handling of the platable layer-use resin composition becomes easy, a polyvalent epoxy compound is preferable. A glycidyl ether type epoxy compound or alicyclic polyvalent epoxy compound is particularly preferably used.

In the platable layer-use resin composition, the amount of the curing agent is preferably 1 to 100 parts by weight with respect to 100 parts by weight of the alicyclic olefin polymer which has a polar group, more preferably 5 to 80 parts by weight, furthermore preferably 10 to 50 parts by weight. By making the amount of the curing agent in the above range, the mechanical strength and electrical characteristics of the cured article which is obtained by curing the laminated film of the present invention can be improved.

Further, the platable layer-use resin composition used in the present invention may contain, in addition to the above ingredients, a hindered phenol compound or hindered amine compound.

The hindered phenol compound is a phenol compound has at least one hindered structure which has a hydroxyl group and which does not have a hydrogen atom at the carbon atom of the β-position of the hydroxyl group in its molecule. As specific examples of the hindered phenol compound, 1,1,3-tris-(2-methyl-4-hydroxy-5-tert-butylphenyl)butane, 4,4′ -butylidenebis-(3-methyl-6-tert-butylphenol), 2,2-thiobis(4-methyl-6-tert-butylphenol), n-octadecyl-3-(4-hydroxy-3,5′ -di-tert-butylphenyl)propionate, tetrakis-[methylene-3-(3′,5′-di-tert-butyl-4′-hydroxyphenyl)propionate]methane, etc. may be mentioned.

The content of the hindered phenol compound in the platable layer-use resin composition is not particularly limited, but is preferably 0.04 to 10 parts by weight with respect to 100 parts by weight of the alicyclic olefin polymer which has a polar group, more preferably 0.3 to 5 parts by weight, furthermore preferably 0.5 to 3 parts by weight. By asking the making of the hindered phenol compound in the above range, it is possible to improve the mechanical strength of the cured article which is obtained by curing the laminated film of the present invention.

Further, the hindered amine compound is a compound which has at least one 2,2,6,6-tetraalkylpiperidine group which has a secondary amine or tertiary amine at the 4-position in its molecule. The number of carbons of the alkyl is usually 1 to 50. As the hindered amine compound, a compound which has at least one 2,2,6,6-tetramethylpiperidyl group which has a secondary amine or tertiary amine at the 4-position in its molecule is preferable. Note that, in the present invention, it is preferable to use both the hindered phenol compound and the hindered amine compound. By using these together, when treating the cured article which is obtained by curing a laminated film of the present invention to roughen its surface by using an aqueous solution of permanganate etc., even when the surface roughening treatment conditions change, it becomes possible to keep the cured article after surface roughening treatment as one low in surface roughness.

As specific examples of the hindered amine compound, bis(2,2,6,6-tetramethyl-4-piperidyl)sebacate, bis(1,2,2,6,6-pentamethyl-4-piperidyl)sebacate, 1-[2-{3-(3,5-di-tert-butyl-4-hydroxyphenyl)propionyloxy}ethyl]-4-{3-(3,5-di-tert-butyl-4-hydroxyphenyl)propionyloxy}-2,2,6,6- tetramethylpiperidine, 8-benzyl-7,7,9,9-tetramethyl-3-octyl-1,2,3-triazaspiro[4,5]undecane-2,4-dione, etc. may be mentioned.

The amount of the hindered amine compound is not particularly limited, but is usually 0.02 to 10 parts by weight with respect to 100 parts by weight of the alicyclic olefin polymer which has a polar group, preferably 0.2 to 5 parts by weight, more preferably 0.25 to 3 parts by weight. By making the amount of the hindered amine compound in the above range, it is possible to improve the mechanical strength of the cured article which is obtained by curing the laminated film of the present invention.

Further, the platable layer-use resin composition used in the present invention may contain a curing accelerator in addition to the above ingredients. As the curing accelerator, a curing accelerator which is mixed into a general resin composition for electrical insulating film forming use may be used, but, for example, a curing accelerator similar to the above-mentioned curable epoxy composition of the present invention may be used. The amount of the curing accelerator in the platable layer-use resin composition may be suitably selected in accordance with the purpose of use, but is preferably 0.001 to 30 parts by weight with respect to 100 parts by weight of the alicyclic olefin polymer which has a polar group, more preferably 0.01 to 10 parts by weight, furthermore preferably 0.03 to 5 parts by weight.

Furthermore, the platable layer-use resin composition used in the present invention may contain a filler in addition to the above ingredients. As the filler, one similar to the filler which is used for the above-mentioned curable epoxy composition can be used. In the platable layer-use resin composition, the amount of the filler, converted to solid content, is usually 1 to 50 wt %, preferably 2 to 45 wt %, more preferably 3 to 35 wt %.

Further, the platable layer-use resin composition used in the present invention may suitably further contain, in addition to the above ingredients, in the same way as the above-mentioned curable epoxy composition of the present invention, a curing accelerator, flame retardant, flame retardant aid, heat resistance stabilizer, weather resistance stabilizer, antiaging agent, ultraviolet, absorber (laser processability improving agent), leveling agent, antistatic agent, slip agent, antiblocking agent, anticlouding agent, lubricant, dye, natural oil, synthetic oil, wax, emulsion, magnetic substance, dielectric characteristic adjuster, toughness agent, or other known ingredients. The ratio of mixture of these optional ingredients may be suitably selected in a range not detracting from the object of the present invention.

The method of production of the platable layer-use resin composition used in the present invention is not particularly limited. The above ingredients can be mixed as they are or may be mixed in the state dissolved or dispersed in an organic solvent. Part of the above ingredients may be dissolved or dispersed in an organic solvent to prepare a composition and the remaining ingredients mixed with that composition.

The laminated film of the present invention is produced using such a platable layer-use resin composition and the above-mentioned curable epoxy composition of the present invention. Specifically, the laminated film of the present invention can for example be produced by the following two methods: (1) the method of production by coating, spraying, or casting the above-mentioned platable layer-use resin composition on a support, drying it as desired, then further coating or casting the above-mentioned curable epoxy composition on that and drying it if necessary and (2) the method of production by laminating a platable layer-use shaped article which is obtained by coating, spraying, or casting the above-mentioned platable layer-use resin composition on a support, drying it as desired, and forming this to a sheet shape or film shape and an adhesive layer-use shaped article which is obtained by coating, spraying, or casting the above-mentioned curable epoxy composition on a support, drying it if necessary, and forming this to a sheet shape or film shape and joining these shaped articles. Among these methods of production, since the process is simpler and the productivity is better, the method of production of the above (1) is preferable.

In the method of production of the above-mentioned (1), when coating, spraying, or casting the platable layer-use resin composition on the support and when, coating, spraying, or casting the curable epoxy composition on the coated, sprayed, or cast platable layer-use resin composition or, in the method of production of the above-mentioned (2), when shaping the platable layer-use resin composition and the curable epoxy composition, into sheet shapes or film shapes to obtain the platable layer-use shaped article and adhesive layer-use shaped article, it is preferable to coat, spray, or cast the platable layer-use resin composition or the curable epoxy composition on the support while adding an organic solvent as desired.
As the support which is used at this time, a resin film or metal foil etc. may be mentioned. As the resin film, a polyethylene terephthalate film, polypropylene film, polyethylene film, polycarbonate film, polyethylene naphthalate film, polyarylate film, nylon film, etc. may be mentioned. Among these films, from the viewpoint of the heat resistance, chemical resistance, peel property, etc., a polyethylene terephthalate film or polyethylene naphthalate film is preferable. As the metal foil, copper foil, aluminum foil, nickel foil, chrome foil, gold foil, silver foil, etc. may be mentioned. Note that, the surface roughness Ra of the support is usually 300 nm or less, preferably 150 nm or less, more preferably 100 nm or less.

The thicknesses of the platable layer-use resin composition and the curable epoxy composition in the method of production of the above-mentioned (1) and the thicknesses of the platable layer-use shaped article and adhesive layer-use shaped article in the method of production of the above-mentioned (2) are not particularly limited, but the thickness of the platable layer when made into a laminated film is preferably 1 to 10 μm, more preferably 1 to 8 μm, furthermore preferably 2 to 5 μm, while the thickness of the adhesive layer is preferably 10 to 100 μm, more preferably 10 to 80 μm, furthermore preferably 15 to 60 μm. If the thickness of the platable layer is too thin, when forming a conductor layer by electroless plating on a cured article which is obtained by curing the laminated film, the formability of the conductor layer is liable to end up falling, while if the thickness of the platable layer is too thick, the cured article which is obtained by curing the laminated film is liable to become larger in linear expansion. Further, if the thickness of the adhesive layer is too small, the wire embedding ability of the laminated film is liable to end up falling.

As the method of coating the platable layer-use resin composition and curable epoxy composition, dip coating, roll coating, curtain coating, die coating, slit coating, gravure coating, etc. may be mentioned.

Further, in the method of production of the above-mentioned (1), after the platable layer-use resin composition is coated, sprayed, or cast on the support or after the curable epoxy composition is coated, sprayed, or cast on the platable layer-use resin composition or, in the method of production of the above-mentioned (2), after the platable layer-use resin composition and the curable epoxy composition are coated on the supports, the compositions may be dried as needed. The drying temperature is preferably made a temperature of an extent where the platable layer-use resin composition and the curable epoxy composition will not cure and is normally 20 to 300° C., preferably 30 to 200° C. Further, the drying time is normally 30 seconds to 1 hour, preferably 1 minute to 30 minutes.

In the laminate film of the present invention, the platable layer and adhesive layer which form the laminated film are preferably in the uncured or semicured state. By making these the uncured or semicured state, it is possible to make the adhesive layer which forms the laminated film of the present invention high in adhesion. Further, the laminated film of the present invention can exhibit the peel strength of the plating by the platable layer.

(Prepreg)

The prepreg of the present invention is comprised of the above-mentioned film of the present invention or laminated film of the present invention in which a fiber base material is included.

As the fiber base material, a polyamide fiber, polyaramide fiber, polyester fiber, or other organic fiber or glass fiber, carbon fiber, or offer inorganic fiber may be mentioned. Further, as the form of the fiber base material, a flat weave or twill weave or other woven fabric or nonwoven fabric etc. may be mentioned. The fiber base material has a thickness of preferably 5 to 100 μm, more preferably 10 to 50 μm. If too thin, the handling becomes difficult, while if too thick, the resin layer becomes relatively thin and its wire embedding ability sometimes becomes insufficient.

When the prepreg of the present invention is comprised of the above-mentioned film of the present invention in which a fiber base material is included, the prepreg of the present invention can be produced by impregnating the curable epoxy composition of the present invention in a fiber base material. In this case, the method of impregnating the curable epoxy composition of the present invention in a fiber base material is not particularly limited, but to add an organic solvent to the curable epoxy composition of the present invention for adjusting the viscosity etc., the method of dipping the fiber base material in the curable epoxy composition to which the organic solvent is added, the method of coating or spraying the curable epoxy composition to which an organic solvent is added on a fiber base material, etc. may be mentioned. In the method of coating or spraying, it is possible to place the fiber base material on a support and coat or spray the curable epoxy composition to which the organic solvent is added on this. Note that, in the present invention, the sheet shape or film shape composite shaped article, in the same way as the above-mentioned sheet shape or film shape article, preferably contains the curable epoxy composition of the present indention in the uncured or semicured state.

Further, after impregnating the curable epoxy composition of the present invention in the fiber base material, it may be dried as desired. The drying temperature is preferably made a temperature of an extent where the curable epoxy composition of the present invention does not cure and is usually 20 to 300° C., preferably 30 to 200° C. If the drying temperature is too high, the curing reaction process too much and the obtained composite shaped article is liable not to become uncured or semicured in state. Further, the drying time is usually 30 seconds to 1 hour, preferably 1 minute to 30 minutes.

Alternatively, when the prepreg of the present invention is comprised of the above-mentioned laminated film of the present invention in which a fiber base material is included, the prepreg of the present invention, preferably has an adhesive layer at one surface, a platable layer at the other surface, and a fiber base material at the inside. The method of production is not limited, but for example this can be produced by the following methods: (1) the method of stacking a curable epoxy composition film with support and a platable layer-use resin composition film with a support to sandwich a fiber base material between them with the resin layer sides of the films facing each other and laminating them as desired under pressure, vacuum, heating, or other conditions; (2) the method of impregnating either the curable epoxy composition or platable layer-use resin composition in a fiber base material and drying it as required so as to prepare a prepreg and coating, spraying, or casting the other resin composition on this prepreg or stacking the other resin composition film with a support; or (3) the method of coating, spraying, or casting, either the curable epoxy opposition or platable layer-use resin composition to a support to form a layer, placing a fiber base material over it, and further coating, spray, or casting the other resin composition over that to form a layer and drying as desired. Note that, in each method, it is preferable to add an organic solvent to each composition as required to adjust the viscosities of the compositions and thereby control the workability when impregnating them in the fiber base material or coating, spraying, or casting them on the support.

As the support which is used at this time, a polyethylene terephthalate film, polypropylene film, polyethylene film, polycarbonate film, polyethylene naphthalate film, polyarylate film, nylon film, or other resin film or copper foil, aluminum foil, nickel foil, chrome foil, gold foil, silver foil, or other metal foil may be mentioned. These may be applied to either just one surface of the prepreg or to both surfaces.

The thickness of the prepreg of the present invention is not particularly limited, but is preferably made a thickness such that the thickness of the platable layer becomes preferably 1 to 10 μm, more preferably 1.5 to 8 μm, furthermore preferably 2 to 5 μm and, further, the thickness of the adhesive layer becomes preferably 10 to 100 μm, more preferably 10 to 80 μm, furthermore preferably 15 to 60 μm.

When producing the prepreg of the present invention, as the method of coating the platable layer-use resin composition and the curable epoxy composition, clip coating, roll coating, curtain coating, die coating, slit coating, gravure coating, etc, my be mentioned.

Further, in the prepreg of the present invention, in the same way as the above-mentioned film and laminated film of the present invention, the resin composition which forms the prepreg is preferably in an uncured or a semicured state.

Then, the prepreg of the present invention which is obtained in the above way may be made into a cured article by heating and curing it.

The curing temperature is usually 30 to 400° C., preferably 70 to 300° C., more preferably 100 to 200° C. Further, the curing time is 0.1 to 5 hours, preferably 0.5 to 3 hours. The method of heating is not particularly limited. For example, an electric oven etc. may be used for this.

(Laminate)

The laminate of the present invention is one obtained by laminating the above-mentioned film, laminated film, or prepreg of the present invention on a base material. The laminate of the present invention may be one obtained by laminating at least the above-mentioned film, laminated film, or prepreg of the present invention, but is preferably one obtained by laminating a substrate which has a conductor layer on its surface and an electrical insulating layer which is comprised of the film, laminated film, or prepreg of the present invention.

The substrate which has a conductor layer on its surface is one which has a conductor layer on the surface of an electrical insulating substrate. The electrical insulating substrate is formed by curing a resin composition which contains a known electrical insulating material (for example, alicyclic olefin polymer, epoxy resin, maleimide resin, (meth)acrylic resin, diallyl phthalate resin, triazine resin, polyphenylene ether, glass, etc.). The conductor layer is not particularly limited, but is usually a layer which includes wiring which are formed by a conductive metal or other conductor and may further include various circuits as well. The configurations, thicknesses, etc. of the wiring and circuits are not particularly limited. As specific examples of a substrate which has a conductor layer on its surface, a printed circuit board, silicon wafer board, etc. may be mentioned. The substrate which has a conductor layer on its surface has a thickness of usually 10 μm to 10 mm, preferably 20 μm to 5 mm, more preferably 30 μm to 2 mm.

The substrate which has a conductor layer on its surface used in the present invention is preferably pretreated on the surface of the conductor layer so as, to improve the adhesion with the electrical insulating layer. As the method of pretreatment, known art can be used without particular limitation. For example, if the conductor layer is comprised of copper, the oxidizing method of bringing a strong alkaline oxidizing solution into contact with the conductor layer surface to form a layer of copper oxide on the conductor surface and roughen it, the method of oxidizing the conductor layer surface by the previous method, then reducing it by sodium borohydride, formalin, etc., the method of depositing plating on the conductor layer to roughen it, the method of bringing an organic acid into contact with the conductor layer to dissolve the grain boundaries of the copper and roughen the layer, the method of forming a primer layer on the conductor layer by a thiol compound, silane compound, etc. and the like may be mentioned. Among these, from the viewpoint of the ease of maintaining the shapes of fine wiring patterns, the method of bringing an organic acid into contact with the conductor layer to dissolve the grain boundaries of the copper and roughen the layer and the method of using thiol compounds or silane compounds etc. to form a primer layer are preferable.

The laminate of the present invention may be produced by hot press bonding, on a substrate which has a conductor layer on its surface, the above-mentioned film of the present invention (that is, the shaped article which is obtained by forming the curable epoxy composition of the present invention into a sheet shape or film shape), laminated film of the present invention (that is, the shaped article of the sheet shape or film shape which is comprised of an adhesive layer of the curable epoxy composition of the present invention and a platable layer), or prepreg of the present invention (the composite shaped article which is comprised of the film of the present invention and a fiber base material or composite shaped article which is comprised of the laminated film of the present, invention and the fiber base material) of the present invention.

As the method of hot pressing, the method of superposing the shaped article with a support or composite shaped article on a substrate to contact the conductor layer and using a press laminator, press machine, vacuum laminator, vacuum press, roll laminator, or other pressure device for hot pressing (lamination) say be mentioned. By hot pressing, it is possible to join the conductor layer on the substrate surface and the shaped article or composite shaped article with substantially no clearance at their interface. The shaped article or composite shaped article is usually laminated on the conductor layer of the substrate in the uncured or semicured state.

The temperature of the hot bonding operation is usually 30 to 250° C., preferably 70 to 200° C., the pressure which is applied is usually 10 kPa to 20 MPa, preferably 100 KPa to 10 MPa, and the pressing time is usually 30 seconds to 5 hours, preferably 1 minute to 3 hours. Further, the hot bonding is preferably performed under reduced pressure to improve burying the wiring patterns into the insulating adhesive film or prepreg or to prevent the formation of bubbles. The pressure of the reduced pressure for performing the hot bonding is usually 100 kPa to 1 Pa, preferably 40 kPa to 10 Pa.

(Cured Article)

The cured article of the present invention is one obtained by curing the curable epoxy composition of the present invention and includes any of the film, laminated film, prepreg, and laminate of the present invention which is comprised of the above composition and has been cured. The curing can be performed by suitably heating the curable epoxy composition or film etc. of the present invention under the later explained curing conditions.

For example, the laminate of the present invention can be made a cured article by treatment to cure the film, laminated film, or prepreg of the present invention forming the same. The curing is usually performed by heating the substrate as a whole on which the film, laminated films, or prepreg of this present invention is formed on the conductor layer. The curing can be performed simultaneously with the above-mentioned hot press bonding operation. Further, the hot press bonding operation may be performed under conditions where curing does not occur, that is, at a relatively low temperature and short time, and then curing performed. The film etc. of the present invention are obtained using the curable epoxy composition of the present invention, but when making the epoxy compounds cure by a triazine structure-containing phenol, resin (C) and active ester compound (D) which acts as a curing agent, the melt viscosity at the tine of heating is low and excellent resin fluidity is exhibited, so an electrical insulating layer which is comprised of the obtained cured resin exhibits an excellent wire embedding ability.

Further, for the purpose of improving the flatness of the electrical insulating layer or the purpose of increasing the thickness of the electrical insulating layer, it is also possible to bond two or more films, laminated films, or prepregs of the present invention on a conductor layer of a substrate for lamination.

The curing temperature is usually 30 to 400° C., preferably 70 to 300° C., more preferably 100 to 200° C. Further, the curing time is usually 0.1 to 5 hours, preferably 0.5 to 3 hours. The method of heating is not particularly limited. For example, an electrical oven etc. may be used for this.

(Composite Article)

The composite article of the present invention is comprised of the cured article of the present invention on the surface of which a conductor layer is formed.

For example, when the laminate of the present invention forms a multilayer board, the composite article of the present invention is comprised of a laminate on the electrical insulating layer of which a still other conductor layer is formed. As this conductor layer, a metal plating or metal foil say be used. As the metal plating material, gold, silver, copper, rhodium, palladium, nickel, tin, etc. may be mentioned. As the metal foil, one which is used as the support of the above-mentioned film, laminated film, or prepreg may be mentioned. Note that, in the present invention, the method of using a metal plating as a conductor layer is preferable from the viewpoint that fine micro wiring can be formed. Below, the method of production of the composite article of the present invention will be explained illustrating a multilayer circuit board which uses a metal plating as a conductor layer as one example of the composite article of the present invention.

First, the laminate is formed with via holes or through holes which pass through the electrical insulating layer. The via holes are formed for connecting the different conductor layers which form a multilayer circuit board when forming a multilayer circuit board. The via holes and through holes can be formed by chemical treatment such as photolithography or by physical treatment such as drilling, laser irradiation, and plasma etching. Among these methods, the method using a laser (CO₂ gas laser, excimer laser, UV-YAG laser, etc.) enables fine via holes to be formed without causing a drop in the characteristics of the electrical insulating layer, so this is preferred.

Next, the surface of the electrical insulating layer of the laminate (that is, the cured article of the present invention) is roughened by surface roughening treatment. The surface roughening treatment is performed so as to enhance the adhesion with the conductor layer which is formed on the electrical insulating layer.

The surface average roughness Ra of the electrical insulating layer is preferably 0.05 μm or more and less than 0.5 μm, more preferably 0.06 or more and 0.3 μm or less, while the surface 10-point average roughness Rzjis is preferably 0.3 μm or more and less than 5 μm, more preferably 0.5 μm or more and 3 μm or less. Note that, in this Description, Ra is the arithmetic average roughness which is shown in JIS B0601-2001, while the surface 10-point average roughness Rzjis is the 10-point average roughness which is shown in JIS B0601-2001 Annex 1.

The method of surface roughening treatment is not particularly method, but the method of bringing the surface of the electrical insulating layer into contact with an oxidizing compound etc. may be mentioned. As the oxidizing compound, an inorganic oxidizing compound or organic oxidizing compound or other known compound which has an oxidizing ability may be mentioned. From the ease of control of the surface average roughness of the electrical insulating layer, use of an inorganic oxidizing compound or organic oxidizing compound is particularly preferable. As the inorganic oxidizing compound, a permanganate, chromic acid anhydride, dichromate, chromate, persulfate, active manganese dioxide, osmium tetraoxide, hydrogen peroxide, periodide, etc. may be mentioned. As the organic oxidizing compound, dicumyl peroxide, octanoyl peroxide, m-chloroperbenzoate, peracetate, ozone, etc. may be mentioned.

The method of using an inorganic oxidizing compound or organic oxidizing compound to roughen the surface of the electrical insulating layer is not particularly limited. For example, the method of dissolving the above oxidizing compound in a solvent which can dissolve it so as to prepare an oxidizing compound solution and bringing this into contact with the surface of the electrical insulating layer may be mentioned. The method of bringing the oxidizing compound solution into contact with the surface of the electrical insulating layer is not particularly limited, but, for example, the dipping method of dipping the electrical insulating layer in the oxidizing compound solution, the buildup method of utilizing the surface tension of the oxidizing compound solution to place the oxidizing compound solution on the electrical insulating layer, the spraying method of spraying the oxidizing compound solution on the electrical insulating layer, or any other method may also be used. By performing the surface roughening treatment, it is possible to improve the adhesion, of the electrical insulating layer with the conductor layer and other layers.

The temperature and the time by which these oxidizing compound solutions are brought into contact with the surface of the electrical insulating layer may be freely set by considering the concentration and type of the oxidizing compound, method of contact, etc., but the temperature is usually 20 to 100° C., preferably 30 to 90° C., while the time is usually 0.5 to 60 minutes, preferably 1 to 40 minutes.

Note that, to remove the oxidizing compound after the surface roughening treatment, the surface of the electrical insulating layer after the surface roughening treatment is washed with water. Further, when a substance which cannot be washed off by just water is deposited on the surface, the surface is further washed by a washing solution which can dissolve that substance or another compound is brought into contact with the surface to convert the substance into one which can be dissolved in water and then the surface is washed by water. For example, when bringing an aqueous solution of potassium permanganate or an aqueous solution of sodium permanganate or other alkali aqueous solution into contact with the electrical insulating layer, to remove the film of manganese dioxide which is formed, if is possible to using a mixed solution of hydroxylamine sulfate and sulfuric acid or other acidic aqueous solution to neutralize/reduce the surface, then wash it by water.

Next, after the electrical insulating layer of the laminate is treated to roughen its surface, a conductor layer is formed on the surface of the electrical insulating layer and the inside wall surfaces of the via holes or through holes.

The method of formation, of the conductor layer is performed, from the viewpoint of enabling formation of a conductor layer which is excellent in adhesion, using the electroless plating method.

For example, when using electroless plating to form a conductor layer, first, before forming a metal thin layer on the surface of the electrical insulating layer, the general practice has been to deposit silver, palladium, zinc, cobalt, or another catalyst nuclei on the electrical insulating layer. The method of depositing catalyst nuclei on the electrical insulating layer is not particularly limited, but, for example, the method of dipping the article in a solution obtained by dissolving silver, palladium, zinc, cobalt, or other metal compounds or their salts or complexes in water, alcohol, chloroform or another organic solvent in 0.001 to 10 wt % in concentration (as desired, also possibly including an acid, alkali, complexing agent, reducing agent, etc.), then reducing the metal etc. may be mentioned.

As the electroless plating solution which is used in the electroless plating, a known self-catalyst type electroless plating solution may be used. It is not particularly limited in the type of metal, the type of reducing agent, the type of complexing agent, the concentration of hydrogen ions, the concentration of dissolved oxygen, etc. which are contained in the plating solution. For example, an electroless copper plating solution which contains ammonium hypophosphite, hypophosphoric acid, ammonium borohydride, hydrazine, formalin, etc. as a reducing agent; an electroless nickel-phosphorus plating solution which contains sodium hypophosphite as a reducing agent; an electroless nickel-boron plating solution which contains dimethylamineborane as a reducing agent; an electroless palladium plating solution; an electroless palladium-phosphorus plating solution which contains sodium hypophosphite as a reducing agent; an electroless gold plating solution; an electroless silver plating solution; an electroless nickel-cobalt-phosphorus plating solution which contains sodium hypophosphite as a reducing agent, or other electroless plating solution can be used.

After forming the metal thin layer, the substrate surface may be brought into contact with a rustproofing agent to make it rustproof. Further, after forming the metal thin layer, the metal thin layer may be heated to raise the adhesiveness. The heating temperature is usually 50 to 350° C., preferably 80 to 250° C. Note that, at this time, the heating may be preformed under pressed conditions. As the pressing method at this time, for example, the method of using a hot press, a pressurizing and heating roll, and other physical pressing means may be mentioned. The pressure which is applied is usually 0.1 to 20 MPa, preferably 0.5 to 10 MPa. If this range, high adhesion can be secured between the metal thin layer and the electrical insulating layer.

The thus formed metal thin layer is formed with a plating-use resist pattern and the plating is further grown over it by electroplating or other wet plating (thickening plating). Next, the resist is removed and the surface is further etched to etch the metal thin layer into the pattern shapes and form the conductor layer. Therefore, the conductor layer which is formed by this method is usually comprised of the patterned metal thin layer and the plating which is grown over that.

Alternatively, when using metal foil instead of metal plating as the conductor layer which forms the multilayer circuit board, the following method can be used for production.

That is, first, the same procedure is followed as above to prepare a laminate which is comprised of an electrical insulating layer comprised of a film or prepreg and a conductor layer comprised of a metal foil. As such a laminate, when laminating and forming, it is preferable to make the curable epoxy composition a hardness enabling the required properties to be held and, due to this, it is preferable to prevent problems when subsequently working it or when forming a multilayer circuit board. In particular, it is preferable to form the laminate under a vacuum. Note that, a laminate which is comprised of such an electrical insulating layer comprised of a film or prepreg and a conductor layer comprised of a metal foil can, for example, be used for a printed circuit board by a known subtractive method.

Further, the prepared laminate is formed with, in the same way as above, via holes or through holes which pass through the electrical insulating layer, then the resin residue in the formed via holes is removed by desmearing the laminate which forms the through holes. The method of desmearing is not particularly limited, but for example the method of causing contact with a solution of permanganate or another oxidizing compound (desmearing solution) may be mentioned. Specifically, the laminate which is formed with the via holes can be dipped in a 60 to 80° C. aqueous solution which is adjusted to a concentration of sodium permanganate of 70 g/liter and a concentration of sodium hydroxide of 40 g/liters for 1 to 50 minutes with shaking so as to desmear it.

Next, after the laminate is desmeared, a conductor layer is formed at the inside wall surfaces of the via holes. The method of forming the conductor layer is not particularly limited, but it is possible to use either the electroless plating method or electroplating method. From the viewpoint of being able to form a conductor layer with a good adhesion, it is possible to use the electroless plating method in the same way as the method of forming a metal plating as the conductor layer.

Next, the inside wall surfaces of the via holes are formed with a conductor layer, then the metal foil is formed with a resist pattern for plating use and further electroplating or other wet plating is used to grow a plating (thick plating), then the resist is removed and the metal foil is further etched to pattern it by etching and form a conductor layer. Therefore, the conductor layer which is formed by this method is comprised of a patterned metal foil and plating which is grown on this.

By using the above obtained multilayer circuit board as the substrate for producing the above-mentioned laminate, hot pressing the above-mentioned shaped article or composite shaped article, and curing the same to form the electrical insulating layer and further forming a conductor layer on this in accordance with the above method, then repeating these steps, it is possible to form a further multilayer structure and thereby possible to obtain the desired multilayer circuit board.

The thus obtained composite article of the present invention (and the multilayer circuit board of one example of the composite article of the present invention) has an electrical insulating layer which is comprised of the curable epoxy composition of the present invention (the cured article of the present invention). The electrical insulating layer is excellent in heat resistance and electrical characteristics with a good balance and furthermore excellent also in adhesion with a conductor layer (in particular, adhesion with the conductor layer after a high temperature and high humidity test), so the composite article of the present invention (and the multilayer circuit board of one example of the composite article of the present invention) can be suitably used for various applications.

(Substrate for Electronic Material Use)

The substrate for electronic material use of the present invention is comprised of the cured article or composite article of the present invention explained above. The substrate for electronic material use of the present invention which is comprised of the cured article or composite article of the present invention can be suitably used for a mobile phone, PHS, laptop PCs, FDAs (personal digital assistants), mobile TV phones, PCs, super computers, servers, routers, liquid crystal projectors, engineering work stations (EWS), pagers, word processors, televisions, viewfinder type or monitor direct viewing type video tape recorders, electronic handheld devices, electronic desktop computers, car navigation systems, POS terminals, devices provided with touch panels, and other various electronic equipment.

### EXAMPLES

Below, examples end comparative examples will be given to more specifically explain the present invention. Note that, in the examples, the “parts” and “%”, unless particularly indicated otherwise, are based on weight. The various types of properties were evaluated by the following methods.

(1) Number Average Molecular Weight (Mn) and Weight Average Molecular insight (Mw) of Alicyclic Olefin Polymer

These were measured using tetrahydrofuran as a developing solvent and using gel permeation chromatography (GPC) and were found as values converted for polystyrene.

(2) Hydrogenation Ratio of Alicyclic Olefin Polymer

The ratio of the number of moles of the unsaturated bonds which were hydrogenated with respect to the number of moles of the unsaturated bonds in the polymer before the hydrogenation was found by measurement of the 400 MHz ¹H-NMR spectrum. This was used as the hydrogenation ratio.

(3) Glass Transition Temperature (Heat Resistance)

From the film-shaped cured article, a small piece of a width 6 mm, length 15.4 mm, and thickness 40 μm was cut. Under conditions of a distance between support points of 10 mm and a temperature elevation rate of 10° C./min, a thermomechanical analyzer (TMA/SDTA840: made by Metler Toledo) was used for measurement to obtain a stress-temperature curve. A tangent was drawn to the inflection point. From the intersecting point of this tangent, the glass transition temperature (Tg) of the film-shaped cured article was found. The heat resistance was evaluated based on the following evaluation criteria. The higher the glass transition, temperature, the better the heat resistance.

(Evaluation Criteria)

A: glass transition temperature of 150° C. or more

B: glass transition temperature of 145° C. to less than 150° C.

C: glass transition temperature of less than 145° C.

(4) Dielectric Tangent (Electrical Characteristics)

A width 2.0 mm, length 80 mm, thickness 40 μm piece was cut out from a film shaped cured article, measured for dielectric tangent (tan δ) at 10 GHz using a resonant cavity perturbation method permittivity measurement apparatus. The electrical characteristics were evaluated in accordance with the following evaluation criteria.

(Evaluation Criteria)

A: dielectric tangent of less than 0.0065

B: dielectric tangent of 0.0065 to less than 0.070

C: dielectric tangent of 0.0070 or more

(5) Initial Adhesion

A thickness 35 μm electrolytic copper foil was etched on its surface by an etchant (product name “CZ-8100”, made by MEC Co., Ltd.) by about 0.5 μm. On the etched surface of the electrolytic copper foil, the film-shaped article was superposed so that its resin layer side contacted it, then a vacuum laminator was used to hot press-bond them under the conditions of a vacuum degree of 1 kPa or less, 90° C., 30 seconds, and pressure 0.7 MPa. Next, the support was peeled off from the surface of the film-shaped article at the opposite side to the resin layer, a glass epoxy copper-clad board (FR-4) which was etched by the etchant by about 2 μm was laid over the surface of the exposed resin layer, then a vacuum laminator was used to hot press-bond them under the same conditions as above. The thus obtained composite shaped article was heated in an oven at 180° C. for 90 minutes to obtain a laminate cured article. The peel strength of the copper foil from the obtained laminate cured article was measured in accordance with JIS C6481 and the following evaluation criteria were used for evaluation.

(Evaluation Criteria)

A: peel strength of 0.55 kN/m or more

B: peel Strength Of 0.30 kN/m to less than 0.55 kN/m

C: peel strength, of less than 0.50 kN/m

(6) Adhesion After High Temperature and High Humidity Test

The same procedure was followed as the above (5) to obtain a laminate cured article. The copper foil at the surface thereof was peeled off leaving a width of 10 mm, but removing the rest. The obtained sample was allowed to stand in a constant temperature and constant humidity tank of a temperature of 130° C. and humidity of 98 % RH for 100 hours, then the peel strength of the copper foil from this laminate cured article was measured in accordance with JIS C6481 and was evaluated based on the following evaluation criteria.

(Evaluation Criteria)

A: peel strength of 0.30 kN/m or more

B: peel strength of 0.25 kN/m to less than 0.30 kN/m

C: peel strength of less than 0.25 kN/m

### Example 1

(Preparation of Curable Epoxy Composition)

50 parts of a polyvalent epoxy compound (A) having a biphenyl structure comprised of a biphenyl dimethylene-based novolac type epoxy resin (product name “NC-3000L”, made by Nippon Kayaku, epoxy equivalent 269), 50 parts of a univalent or higher polyvalent phenol type epoxy compound (B) comprised of a tetrakishydroxyphenylethane-type epoxy expound (product name “jER 1031S”, made by Mitsubishi Chemical, epoxy equivalent 200, softening point 90° C.), 30 parts of the triazine structure-containing phenol resin (C) comprised of a triazine structure-containing cresol novolac resin (product name “Phenolite LA-3018-50P” (nonvolatile content 50% propylene glycol monomethylether solution, made by DIC, active hydroxyl group equivalent 154) (15 parts converted to triazine structure-containing cresol novolac resin), 115.3 parts of, as an active ester compound (D), active ester compound (product name “Epiclon HPC-8000-65T”, nonvolatile content 65% toluene solution, made by DIC, active ester group equivalent 223) (75 parts converted to active ester compound), 350 parts of a filler comprised of silica (product name “SC2500-SXJ”, made by Admatechs), 1 part of an antiaging agent comprised of a hindered phenol-based antioxidant (product name “Irganox (registered trademark; 3114”, made by BASF), and 110 parts of anisole were mixed and stirred by a planetary mixer for 3 minutes. Furthermore, to this, 8.3 parts of a curing accelerator comprised of a solution of 30% of 1-benzyl-2-phenylimidazole dissolved in anisole (2.5 parts converted to 1-benzyl-2-phenylimidazole) was mixed and stirred by a planetary mixer for 5 minutes to obtain a varnish of a curable epoxy composition. Note that, in the varnish, the content of the filler was 64% converted to solid content.

(Preparation of Film-Shaped Article)

Next, the above obtained varnish of the curable epoxy composition was applied by a die coater on a vertical 300 mm×horizontal 300 mm size, thickness 38 μm, surface average roughness Ra 0.08 μm polyethylene terephthalate film (support: Lumirror (registered trademark) T60, made by Toray Industries Inc.), then dried in a nitrogen atmosphere at 80° C. for 10 minutes to obtain a film shaped article of thickness 43 μm resin composition on a support. The obtained film-shaped article was used in accordance with the above method to evaluate the desmearing ability and adhesion. The obtained film-shaped article was used in accordance with the above methods to evaluate the initial adhesion and adhesion after a high temperature and high humidity test. The results are shown in Table 1.

(Preparation of Film-Shaped Cured Article)

Next, a piece which was cut out from the thus obtained film shaped article of the curable epoxy composition was placed on a thickness 10 μm copper foil. This was set, in the state, with the support attached, so that the curable epoxy composition became the inside. A vacuum laminator which was provided with heat resistant rubber press plates at the top and bottom was used to reduce the pressure to 200 Pa and hot press bond the laminate at a temperature of 110° C. and a pressure of 0.1 MPa for 60 seconds, the support was peeled off, then the laminate was heated and cured at 180° C. for 120 minutes in the air. After curing, the copper foil is cut from cured resin with the copper foil, then the cut copper foil was dissolved in a 1 mol/liter ammonium persulfate aqueous solution to obtain a film shaped cured article. The obtained film shaped cured article was used in accordance with the above methods to measure the glass transition temperature and dielectric tangent. The results are shown in Table 1.

### Examples 2 to 5 and Comparative Examples 1 to 5

Except for changing the formulations in accordance with the compositions of the curable epoxy compositions in Examples 2 to 5 and comparative Examples 1 to 5 of Table 1, the same procedure was followed as in Example 1 to obtain a varnish of a curable epoxy composition, a film-shaped article, and a film-sloped cured article and the same procedure was followed to measure and evaluate them. The results are shown in Table 1.

Note that, in Table 1, the “trishydroxyphenylmethane-type epoxy compound” is trivalent or higher polyvalent phenol type epoxy compound (B) comprised of the trishydroxyphenylmethane-type epoxy compound (product name “jER 1032H”, made by Mitsubishi Chemical, epoxy equivalent 170, softening point 60° C.) , the “phenol-based novolac type epoxy compound having a phosphaphenanthrene structure” is phenol-based novolac type epoxy compound having a phosphaphenanthrene structure (product name “FX-289BEK75”, made by Nippon Steel & Sumikin Chemical, solid content 75% methylethylketone solution, phosphorus content 2%, epoxy equivalent 305), and the “bisphenol A type epoxy compound” is bisphenol A type epoxy compound (product name “jER 828EL”, made by Mitsubishi Chemical, epoxy equivalent 186, liquid state).

### Table 1

TABLE 1

| Examples | | | | | Comparative Examples | | | | |
|---|---|---|---|---|---|---|---|---|---|
| 1 | 2 | 3 | 4 | 5 | 1 | 2 | 3 | 4 | 5 |

Composition of curable epoxy composition (parts)

| | | | | | | | | | | | |
|---|---|---|---|---|---|---|---|---|---|---|---|
| Epoxy | Polyvalent epoxy compound having | 50 | 80 | 50 | 80 | 60 | 100 | | | 50 | 15 |
| compound | biphenyl structure | | | | | | | | | | |
| | Tetrakishydroxyphenylethane-type epoxy | 50 | 20 | | | 15 | | 100 | | 50 | |
| | compound | | | | | | | | | | |
| | Trishydroxyphenylmethane-type epoxy | | | 50 | 20 | | | | 100 | | |
| | compound | | | | | | | | | | |
| | Epoxy compound having | | | | | 25 | | | | | |
| | phosphaphenanthrene structure | | | | | | | | | | |
| | Bisphenol A type epoxy compound | | | | | | | | | | 85 |

| | | | | | | | | | | |
|---|---|---|---|---|---|---|---|---|---|---|
| Triazine structure-containing phenol resin (C) | 15 | 15 | 15 | 15 | 15 | 15 | 15 | 15 | | 15 |
| Active ester compound (D) | 75 | 67 | 85 | 70 | 65 | 60 | 90 | 110 | 100 | 90 |
| Silica | 350 | 340 | 370 | 350 | 340 | 330 | 380 | 420 | 370 | 380 |
| Antiaging agent | 1 | 1 | 1 | 1 | 1 | 1 | 1 | 1 | 1 | 1 |
| Curing accelerator | 2.5 | 2.5 | 2.5 | 2.5 | 2.5 | 2.5 | 2.5 | 2.5 | 2.5 | 2.5 |
| Equivalent ratio of epoxy compound/ | 1.00 | 0.99 | 1.00 | 1.00 | 0.98 | 1.01 | 0.99 | 0.99 | 0.97 | 1.01 |
| (triazine structure-containing phenol resin (C) + | | | | | | | | | | |
| active ester compound (D)) | | | | | | | | | | |

Results of evaluation

| | | | | | | | | | | |
|---|---|---|---|---|---|---|---|---|---|---|
| Heat resistance (glass transition temperature) | A | A | A | A | A | C | A | A | A | C |
| Electrical characteristics (dielectric tangent) | A | A | B | A | A | A | C | C | A | A |
| Initial adhesion | A | A | A | A | A | A | B | B | C | B |
| Adhesion after high temperature and high humidity test | A | A | A | A | A | A | B | B | C | C |

As shown in Table 1, according to the curable epoxy composition of the present invention, a film-shaped cured article excellent in heat resistance, electrical characteristics, and initial adhesion and adhesion after a high temperature and high humidity test was obtained (Examples 1 to 5). Therefore, it is confirmed that according to the curable epoxy composition of the present invention, it is possible to form an electrical insulating layer having such excellent properties.

On the other hand, when not containing a trivalent or higher polyvalent phenol type epoxy compound (B), the obtained film-shaped cured article becomes inferior in heat resistance as a result (Comparative Example 1). Further, when not containing a polyvalent epoxy compound (A) having a biphenyl structure and/or condensed polycyclic structure, the obtained film-shaped cured article becomes inferior in electrical characteristics as a result (Comparative Examples 2 and 3).

Furthermore, when not containing a triazine structure-containing phenol resin (C), the obtained film-shaped cured article becomes inferior in initial adhesion and adhesion after a high temperature and high humidity test as a result (Comparative Example 4), while when using instead of the trivalent or higher polyvalent phenol type epoxy compound (B), a bisphenol A type epoxy compound, the obtained film shaped cured article becomes inferior in heat resistance and adhesion after a high temperature and high humidity test (Comparative Example 5).

### Synthesis Example 1

As a first stage of polymerization, 5-ethylidene-bicyclo[2.2.1]hept-2-ene was charged in 35 molar parts, 1-hexene in 0.9 molar part, anisole in 340 molar parts, and C1063 in 0.005 molar part to a pressure resistant glass reactor with the inside substituted with nitrogen. Under stirring, a polymerization reaction was performed at 80° C. for 30 minutes to obtain a solution of a norbornene-based ring opened polymer.

Next, as a second stage of polymerization, in the solution obtained at the first stage of polymerization, 45 molar parts of tetracyclo[6.5.0.1^{2,5}.0^{8,13}]trideca-3,8,10,12-tetraene, 20 molar parts of bicyclo[2.2.1]hept-2-ene-5,6-dicarboxylic acid anhydride, 250 molar parts of anisole, and 0.01 molar part of a ruthenium-based polymerization catalyst comprised of 4-acetoxybenzylidene(dichloro) (4,5-dibromo-1,3-dimesityl-4-imidazolin-2-ylidene) (tricyclohexylphosphene)ruthenium (C1063, made by Wako Pure Chemical) were added. Under stirring, a polymerization reaction was caused at 80° C. for 1.5 hours to obtain a norbornene-based ring opened polymer. When measuring this solution by gas chromatography, it was confirmed that substantially no monomers remained. The polymerization conversion rate was 99% or more.

Next, an autoclave with a stirrer with the inside substituted with nitrogen was charged with a solution of the obtained ring-opened polymer, 0.03 molar part of C1063 was added, and a hydrogenation reaction was performed at 150° C. at a hydrogen pressure of 7 MPa for 5 hours to obtain a solution of a hydrogenated article of a norbornene-based ring-opened polymer comprised of the alicyclic type olefin polymer (1). The weight average molecular weight of the alicyclic type olefin polymer (1) was 60,000, the number average molecular weight of 30,000, and the molecular weight distribution was 2. Further, the hydrogenation rate was 95%, while the content of the repeating units having a carboxylic acid anhydride group was 20 mol %. The solid content concentration of the solution of the alicyclic type olefin polymer (1) was 22%.

### Example 6

(Platable Layer-Use Resin Composition)

454 parts of the solution of the alicyclic olefin polymer (1) which was obtained in Synthesis Example 1 (converted to alicyclic olefin polymer (1), 100 parts, 36 parts of a polyvalent epoxy compound which has a dicyclopentadiene structure (“Epiclon HP7200L”, made by DIC, “Epiclon” is a registered trademark) as a curing agent, 24.5 parts of an inorganic filler constituted by silica (“Admafine SO-C1”, made by Admatechs, average particle size 0.25 μm, “Admafine” is a registered trademark), 1 part of tris(3,5-di-t-butyl-4-hydroxybenzyl)-isocyanurate (“Irganox (registered trademark) 3114”, made by BASF) as an antiaging agent, 0.5 part of 2-[2-hydroxy-3,5-bis(α,α-dimethylbenzyl)phenyl]-2H-benzotriazole benzotriazole as an ultraviolet absorber, and 0.5 part of 1-benzyl-2-phenylimidazole as a curing accelerator were mixed in anisole and mixed to give a concentration of the compounding agents of 16% so as to obtain a varnish of the platable layer-use resin composition.

(Preparation of Laminated Film)

The varnish of the platable layer-use resin composition, which was obtained above was applied on a thickness 38 μm polyethylene terephthalate film (support) by using a wire bar, then was dried in a nitrogen atmosphere at 80° C. for 10 minutes to obtain a film with a support on which a thickness 3 μm platable layer comprised of an uncured platable layer-use resin composition was formed.

Next, the surface of the film with the support on which the platable layer comprised of the platable layer-use resin composition was formed was coated with the varnish of the curable epoxy composition which was obtained in Example 1 by using a doctor blade (made by Tester Sangyo Co., Ltd) and an auto film applicator (made by Tester Sangyo Co., Ltd), then was dried in a nitrogen, atmosphere at 80° C. for 10 minutes to obtain a laminated film with the support on which a total thickness 43 μm platable layer and adhesive layer were formed. The laminated film with the support was formed by the support, the platable layer comprised of the platable layer-use resin composition, and the adhesive layer comprised of the curable epoxy composition in that order.

(Preparation of Laminate Cured Article)

Next, separate from the above, a varnish which contains glass filler and a halogen-free epoxy resin was impregnated in glass fibers to obtain a core material. On the surfaces of this, thickness 18 μm copper was bonded to obtain a thickness 0.8 mm, 150 mm square (vertical 150 mm and horizontal 150 mm) two-sided copper-clad substrate. On the surfaces of this, conductor layers with interconnect widths and interconnect pitches of 50 μm and thicknesses of 30 μm and with surfaces microetched by contacting an organic acid were formed to obtain an inside layer substrate.

At the two surfaces of the inside layer substrate, the above obtained laminated film with the support cut into 150 mm square pieces were bonded with the surfaces at the curable epoxy composition sides becoming the insides, then the laminate was pressed by primary pressing. The primary pressing was hot press bonding by a vacuum laminator which is provided with press plates made of heat resistant rubber at the top and bottom under a reduced pressure of 200 Pa at a temperature 110° C. with a pressure of 0.1 MPa for 90 seconds. Furthermore, a hydraulic press apparatus which is provided with metal press plates at the top and bottom was used for hot press bonding at a press bonding temperature of 110° C. and 1 MPa for 90 seconds. Next, the supports were peeled off to obtain a laminate of a resin layer which was comprised of the curable epoxy composition and the platable layer-use resin composition and the inside layer substrate. Furthermore, the laminate was allowed to stand in an air atmosphere at 180° C. for 60 minutes to make the resin layer cure and form an electrical insulating layer on the inside layer substrate.

(Swelling Treatment Step)

The obtained laminate cured article was dipped while shaking in a 60° C. aqueous solution which was prepared to contain a swelling solution (°Swelling Dip Securiganth P°, made by Atotech, “Securiganth” is a registered trademark) 500 ml/liter and sodium hydroxide 3 g/liter for 15 minutes, then was rinsed.

(Oxidizing Treatment Step)

Next, the laminate cured article was dipped while shaking in an 80° C. aqueous solution which was prepared to contain an aqueous solution of permanganate (“Concentrate Compact CP”, made by Atotech) 640 ml/liter and a concentration of sodium hydroxide of 40 g/liter for 20 minutes, then was rinsed.

(Neutralizing/Reduction Treatment Step)

Next, the laminate cured article was dipped in a 40° C. aqueous solution which was prepared to contain an aqueous solution of 100 ml/liter of hydroxylamine sulfate (“Reduction Securiganth P 500”, made by Atotech, “Securiganth” is a registered trademark) and 35 ml/liter of sulfuric acid for 5 minutes to neutralize and reduce it, then was rinsed.

(Cleaner/Conditioner Step)

Next, the laminate cured article was dipped in a 50° C. aqueous solution which was prepared to contain a cleaner/conditioner aqueous solution (“Alcup MCC-6-A”, made by Uyemura & Co., Ltd. “Alcup” is a registered trademark) of a concentration of 50 ml/liter for 5 minutes to treat it with the cleaner and conditioner. Next, the laminate was dipped in 40° C. rinsing water for 1 minute, then was rinsed.

(Soft Etching Step)

Next, the laminate cured article was dipped in an aqueous solution which was prepared to contain a sulfuric acid concentration of 100 g/liter and sodium persulfate of 100 g/liter for 2 minutes to be soft etched, then was rinsed.

(Pickling Step)

Next, the laminate cured article was dipped in an aqueous solution which was prepared to contain a sulfuric acid concentration of 100 g/liter for 1 minute to be pickled, then was rinsed.

(Catalyst Imparting Step)

Next, the laminate cured article was dipped in a 60° C. Pd salt-containing plating catalyst aqueous solution which was prepared to contain 200 ml/liter of Alcup Activator MAT-1-A (product name, made by Uyemura & Co., Ltd. “Alcup” is a registered trademark), 30 ml/liter of Alcup Activator MAT-1-B (product name, made by Uyemura & Co., Ltd. “Alcup” is a registered trademark), and 0.35 g/liter of sodium hydroxide for 5 minutes, then was rinsed.

(Activation Step)

Next, the laminate cured article was dipped in an aqueous solution which was prepared to contain 50 ml/liter of Alcup Reducer MAB-4-A (product name, made by Uyemura & Co., “Alcup” is a registered trademark) and 200 ml/liter of Alcup-Reducer MAB-4-B (product name, made by Uyemura & Co., Ltd. “Alcup” is a registered trademark) at 35° C. for 3 minutes to reduce the plating catalyst, then was rinsed.

(Accelerator Treatment Step)

Next, the laminate cured article was dipped in an aqueous solution which was prepared to contain 50 ml/liter of Alcup Accelerator MEL-3-A (product name, made by Uyemura & Co., Ltd. “Alcup” is a registered trademark) at 25° C. for 1 minute.

(Electroless Plating Step)

The thus obtained laminate eared article was dipped in an electroless copper plating solution which was prepared to contain 100 ml/liter of Thru-Cup PEA-6-A (product name, made by Uyemura & Co., Ltd. “Thru-Cup” is a registered trademark), 50 ml/liter of Thru-Cop PEA-6-B-2X (product name, made by Uyemura & Co. Ltd.), 14 ml/liter of Thru-Cup PEA-6-C (product name, made by Uyemura & Co. Ltd.), 15 ml/liter of Thru-Cup PEA-6-D (product name, made by Uyemura & Co. Ltd.) 50 ml/liter of Thru-Cup PEA-6-E (product name, made by Uyemura & Co. Ltd.), and 5 ml/liter of 37 wt % formalin aqueous solution, while blowing in air, at a temperature of 36° C. for 20 minutes for electroless copper plating so as to form an electroless plating film on the laminate cured article surface (surface of platable layer comprised of platable layer-use resin composition).

Next, the laminate cured article which was formed with the electroless plating film was annealed in an air atmosphere at 150° C. for 30 minutes.

The annealed laminate cured article was electroplated with copper to form a thickness 30 μm electroplated copper layer. Next, the laminate cured article was heat treated at 180° C. for 60 minutes to thereby obtain a two-sided two-layer multilayer printed circuit board comprised of a laminate-cured article on which a conductor layer comprised of a thin metal layer and electroplated copper film.

1. A curable epoxy composition comprising a polyvalent epoxy compound (A) having a biphenyl structure and/or condensed poly cyclic structure, a trivalent or higher polyvalent phenol type epoxy compound (B), and a triazine structure-containing phenol resin (C).

2. The curable epoxy composition according to claim 1, wherein the trivalent or higher polyvalent phenol type epoxy compound (B) includes an epoxy compound having a structure represented by the following general formula (1): 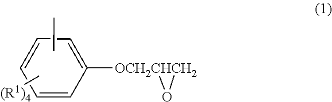
where, in formula (1), each of R¹ respectively independently indicates a hydrogen atom or hydrocarbon group having 1 to 3 carbon atoms.

3. The curable epoxy composition according to claim 1, wherein the trivalent or higher polyvalent phenol type epoxy compound (B) includes an epoxy compound having any one of structures represented by the following general formulas (2) to (5): 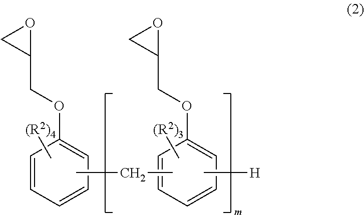
where, in formula (2), each of R² respectively independently indicates a hydrogen atom or hydrocarbon group having 1 to 3 carbon atoms, and “m” is an integer of 2 or more, and 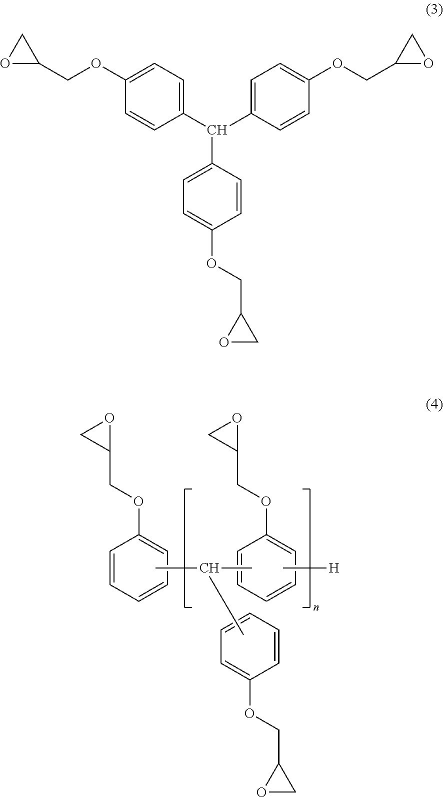
where, in formula (4), “n” indicates a positive integer.

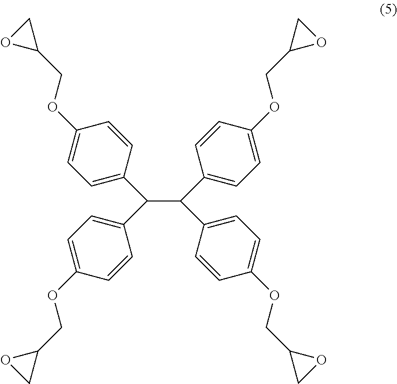 [SMILES: c1cc(C(c2ccc(OCC3CO3)cc2)C(c2ccc(OCC3CO3)cc2)c2ccc(OCC3CO3)cc2)ccc1OCC1CO1]

4. The curable epoxy composition according to claim 1, wherein a ratio of content of the polyvalent epoxy compound (A) and the trivalent or higher polyvalent phenol type epoxy compound (B) is, by a weight ratio of “polyvalent epoxy compound (A):trivalent or higher polyvalent phenol type epoxy compound (B)”, 20:80 to 95:5.

5. The curable epoxy composition according to claim 1, wherein a ratio of content of the triazine structure-containing phenol resin (C) is 1 to 60 parts by weight with respect to 100 parts by weight of total of epoxy compound contained in the curable epoxy composition.

6. The curable epoxy composition according to claim 1, further comprising an active ester compound (D).

7. A film comprising a curable epoxy composition according to claim 1.

8. A laminated film comprising a binder layer which comprises the curable epoxy composition according to claim 1 and a platable layer which comprises a platable layer-use resin composition.

9. A prepreg comprising the film according to claim 7 and a fiber base material.

10. A laminate obtained by laminating a substrate with the film according to claim 7.

11. A cured article obtained by curing the curable epoxy composition according to claim 1.

12. A composite article obtained by forming a conductor layer on a surface of the cured article according to claim 11.

13. A board for an electronic material comprising the cured article according to claim 11.

14. A cured article obtained by curing the film according to claim 7.

15. A cured article obtained by curing the laminated film according to claim 8.

16. A cured article obtained by curing the prepreg according to claim 9.

17. A cured article obtained by curing the laminate according to claim 10.

18. A composite article obtained by forming a conductor layer on a surface of the cured article according to claim 14.

19. A composite article obtained by forming a conductor layer on a surface of the cured article according to claim 15.

20. A composite article obtained by forming a conductor layer on a surface of the cured article according to claim 16.

21. A composite article obtained by forming a conductor layer on a surface of the cured article according to claim 17.
